(19) United States
(12) Patent Application Publication
(10) Pub. No.: US 2026/0217585 A1
(43) Pub. Date: Jul. 30, 2026

(54) Stormwater Waste Decanting Process Utilizing Clinoptilolite Zeolite Powder and Granules for Faster and more Efficient Liquid Separation and Toxin Encapsulation

(71) Applicants: Dan Uhm, Seattle, WA (US); Thomas S Yang, Shoreline, WA (US)

(72) Inventors: Dan Uhm, Seattle, WA (US); Thomas S Yang, Shoreline, WA (US)

(73) Assignee: Agrinutrient, LLC, Seattle, WA (US)

(21) Appl. No.: 19/041,948

(22) Filed: Jan. 30, 2025

(51) Int. Cl. C02F 11/00; B01J 20/16; C02F 101/20; C02F 103/00

(52) U.S. Cl. CPC C02F 11/004; B01J 20/165; C02F 2101/20; C02F 2103/001; C02F 2303/06; C02F 2305/00

(57) ABSTRACT

Stormwater waste processing is an important part of disposing of waste collected from the cleaning and maintenance of stormwater management systems. Currently significant time is needed to process stormwater waste requiring the building of many stormwater waste decant facilities. By using clinoptilolite zeolite in the stormwater waste decant process there is significant reduction in time needed to safely process and dispose of the stormwater waste. Also the clinoptilolite zeolite absorbs and adsorbs heavy metals and toxins making the waste safer to handle and dispose of. Thus the addition of Clinoptilolite Zeolite to stormwater waste sludge significantly increases throughput by greatly reducing the processing time and also enhances the adsorption of lead and other heavy metals.

### FIELD OF THE INVENTION

This invention relates to stormwater waste management and environmental remediation. Specifically, it concerns stormwater waste using a decanting process that employs clinoptilolite zeolite powder and granules to separate liquid from sludge while simultaneously encapsulating and trapping harmful toxins and heavy metals prior to incineration.

### BACKGROUND OF THE INVENTION

Most stormwater waste decant facilities consists of a covered building with concrete tanks. Stormwater eductor trucks decant their liquid load onto the slab, where it drains into tanks. The liquid is moved through a series of tanks to settle any remaining solids out. Once settled, the decanted waste liquid is pumped to a treatment plant. The solid “sludge” material still contains some remainder of waste liquid and this liquid slowly evaporates over time. Once this sludge material has adequately solidified with the removal of liquid, the solid waste can then be removed and disposed of safely and then the cycle can repeat which currently takes quite some time.

At present, the process of decanting stormwater waste takes several days to months depending upon the facility. Once a decant facility has reached full capacity, new facilities must be constructed. Clinoptilolite zeolite reduces the decant time from days and months to 30 minutes or less, allowing more stormwater waste to be processed in the same amount of time thus making each decant facility significantly more efficient resulting in greater throughput.

Stormwater waste frequently contains high levels of contaminants, including heavy metals, hydrocarbons, and organic pollutants. Traditional decanting methods separate liquid from sludge, but they do not effectively encapsulate hazardous substances within the sludge, leading to challenges in disposal and potential environmental harm.

Clinoptilolite zeolite is a highly effective absorbent and adsorbent due to its unique crystalline structure, high cation exchange capacity (CEC), and strong affinity for various pollutants. Below are the key reasons why clinoptilolite is excellent for absorption and adsorption:
Clinoptilolite zeolite can absorb up to 30% of its weight in water. This makes it valuable in moisture control applications, such as desiccants, animal feed additives, and drying agents. Unlike other absorbents, clinoptilolite zeolite retains its structure even when saturated, allowing for repeated use.
Clinoptilolite zeolite has a microporous, honeycomb-like framework with uniformly sized pores. This allows it to trap and hold a variety of molecules, including water, heavy metals, and organic contaminants. The high porosity increases its surface area, enhancing its adsorption capacity. Its CEC makes it particularly useful in wastewater treatment, soil remediation, and stormwater filtration.

Clinoptilolite zeolite, a naturally occurring microporous aluminosilicate, is known for its high cation exchange capacity and strong adsorption properties. It has demonstrated efficacy in capturing heavy metals, ammonia, and organic pollutants from wastewater.

There remains a need for an improved stormwater decanting method that not only separates liquid efficiently but also stabilizes contaminants within the sludge, making it safer for disposal or incineration.

### SUMMARY OF THE INVENTION

The present invention provides a stormwater decanting process that incorporates clinoptilolite zeolite powder and granules to enhance liquid removal from stormwater sludge while simultaneously encapsulating toxins and heavy metals. The process includes the following steps:
1. Collection of Stormwater Sludge—Contaminated stormwater is gathered in a designated containment system and taken to a stormwater waste decant facility.
2. Initial Stormwater Waste Decanting—Stormwater waste is decanted in the usual fashion.
3. Application of Clinoptilolite Zeolite—A predetermined amount of clinoptilolite zeolite powder and granules is introduced into the sludge.
4. Mixing and Adsorption—The clinoptilolite zeolite interacts with the sludge, adsorbing heavy metals and other toxins through ion exchange and physical entrapment.
5. Stormwater Waste Sludge Decantation—Liquid water is separated from the treated sludge, reducing its volume and preparing it for incineration or disposal.
6. Final Solidification and Disposal—The sludge, now containing immobilized contaminants, is safely transported for incineration/disposal, preventing toxic leachate formation.

### DETAILED DESCRIPTION OF THE INVENTION

The stormwater decanting system consists of a containment unit where stormwater waste sludge is collected. A metered dosing system introduces clinoptilolite zeolite powder and granules at an optimal ratio based on sludge composition and pollutant concentration.

Upon mixing, the clinoptilolite zeolite facilitates the agglomeration of fine particles and the adsorption of contaminants. The treated sludge is then subjected to a decanting phase, allowing the clarified water to be extracted for further treatment or discharge. The resulting sludge is significantly drier for transportation.

Zeolite's unique properties enable it to retain hazardous metals such as lead, and arsenic within its porous matrix. This helps mitigate the problem of these toxins leaching into the environment.

### ADVANTAGES OF THE INVENTION

Enhanced Liquid Removal: Accelerates decantation, reducing sludge moisture

content.
Heavy Metal Encapsulation: Limits leaching of toxic substances.
Environmentally Friendly: Utilizes a natural mineral to improve stormwater treatment.

### POTENTIAL APPLICATIONS

Municipal stormwater treatment plants
Industrial wastewater processing
Hazardous waste containment sites
Environmental remediation projects

### CONCLUSION

This stormwater waste decanting system offers an innovative and sustainable approach to stormwater waste sludge management. By utilizing clinoptilolite zeolite, the method ensures safer, more efficient separation and disposal of stormwater contaminants, contributing to improved environmental stewardship and waste management practices.

1. The addition of clinoptilolite zeolite to stormwater waste sludge significantly increases throughput by greatly reducing the processing time.

2. Clinoptilolite zeolite-treated sludge exhibits reduced water content, facilitating efficient decanting.

3. Clinoptilolite zeolite enhances the adsorption of lead and other heavy metals.
